(19) United States
(12) Patent Application Publication
(10) Pub. No.: US 2022/0248258 A1
(43) Pub. Date: Aug. 4, 2022

(54) EHT RELEASE 2 DEVICE INDICATION

(71) Applicant: Samsung Electronics Co., Ltd., Suwon-si (KR)

(72) Inventors: Ruchen DUAN, Santa Clara, CA (US); Wook Bong LEE, San Jose, CA (US); Srinivas KANDALA, Morgan Hill, CA (US); Ravi GIDVANI, Fremont, CA (US); Jonghun HAN, Gwacheon-si (KR); Chulho CHUNG, Yongin-si (KR); Ashok RANGANATH, Los Gatos, CA (US)

(21) Appl. No.: 17/579,520

(22) Filed: Jan. 19, 2022

Related U.S. Application Data
(60) Provisional application No. 63/145,267, filed on Feb. 3, 2021.

(51) Int. Cl. H04W 28/02; H04L 69/22; H04W 28/20

(52) U.S. Cl. CPC H04W 28/0273; H04W 28/0215; H04W 28/20; H04L 69/22

(57) ABSTRACT

A system and method for selecting values for Validate and Disregard bits. In some embodiments, the method includes: receiving, by a first wireless station, from a second wireless station, an information element reporting capabilities of the second wireless station; and determining, by the first wireless station, based on the information element, whether to transmit, to the second wireless station, a default value for each of a plurality of Validate bits and for each of a plurality of Disregard bits.

### CROSS-REFERENCE TO RELATED APPLICATION(S)

The present application claims priority to and the benefit of U.S. Provisional Application No. 63/145,267, filed Feb. 3, 2021, entitled “EXTREMELY HIGH THROUGHPUT (EHT) RELEASE 2 DEVICE INDICATION”, the entire content of which is incorporated herein by reference.

### FIELD

One or more aspects of embodiments according to the present disclosure relate to WiFi communications, and more particularly to a system and method for selecting values for Validate and Disregard bits.

### BACKGROUND

The WiFi standard 802.11 be is being defined in two releases, a first release (Release 1) and a second release (Release 2). A WiFi station (STA) may conform with 802.11 be Release 1 or with 802.11 be Release 2. Sending non-default values for The Disregard or Validate bits to a STA may have different effects depending on whether the STA is a Release 1 STA or a Release 2 STA. In particular, transmitting Disregard or Validate bits with values differing from the default values to a Release 1 STA may cause a failure in reception.

It is with respect to this general technical environment that aspects of the present disclosure are related.

### SUMMARY

According to an embodiment of the present disclosure, there is provided a method, including: receiving, by a first wireless station, from a second wireless station, an information element reporting capabilities of the second wireless station; and determining, by the first wireless station, based on the information element, whether to transmit, to the second wireless station, a default value for each of a plurality of Validate bits and for each of a plurality of Disregard bits.

In some embodiments, the determining of whether to send the default value for each of the plurality of Validate bits includes determining a version of the second wireless station.

In some embodiments, the version is: Release 1 of WiFi standard 802.11 be, or Release 2 of WiFi standard 802.11 be.

In some embodiments: the information element is an Extremely High Throughput Capabilities element, and the determining includes inferring, from the information element, the version.

In some embodiments, the inferring includes inferring from a first bit being set to a first value that the version is Release 2, the first bit being a Release 1 reserved bit and the first value being a non-default value of the first bit.

In some embodiments, the inferring includes inferring from the length of the information element that the version is Release 2.

In some embodiments, the inferring includes inferring from the length of the information element that the version is Release 1.

In some embodiments: the determining includes determining from a first bit being set to a first value that the version is Release 2, and the first bit is a version-indicating bit.

In some embodiments: the version is Release 1, and the method further includes transmitting, to the second wireless station, the default value for each of the plurality of Validate bits and for each of the plurality of Disregard bits.

According to an embodiment of the present disclosure, there is provided a system, including: a first wireless station including a radio and a processing circuit, the processing circuit being configured to: receive, from a second wireless station, an information element reporting capabilities of the second wireless station; and determine, based on the information element, whether to transmit, to the second wireless station, a default value for each of a plurality of Validate bits and for each of a plurality of Disregard bits.

In some embodiments, the determining of whether to send the default value for each of the plurality of Validate bits includes determining a version of the second wireless station.

In some embodiments, the version is: Release 1 of WiFi standard 802.11 be, or Release 2 of WiFi standard 802.11 be.

In some embodiments: the information element is an Extremely High Throughput Capabilities element, and the determining includes inferring, from the information element, the version.

In some embodiments, the inferring includes inferring from a first bit being set to a first value that the version is Release 2, the first bit being a Release 1 reserved bit and the first value being a non-default value of the first bit.

In some embodiments, the inferring includes inferring from the length of the information element that the version is Release 2.

In some embodiments, the inferring includes inferring from the length of the information element that the version is Release 1.

In some embodiments: the determining includes determining from a first bit being set to a first value that the version is Release 2, and the first bit is a version-indicating bit.

In some embodiments: the version is Release 1, and the processing circuit is further configured to transmit, to the second wireless station, the default value for each of the plurality of Validate bits and for each of the plurality of Disregard bits.

According to an embodiment of the present disclosure, there is provided a system, including: a first wireless station including a radio and means for processing, the means for processing being configured to: receive, from a second wireless station, an information element reporting capabilities of the second wireless station; and determine, based on the information element, whether to transmit, to the second wireless station, a default value for each of a plurality of Validate bits and for each of a plurality of Disregard bits.

In some embodiments: the determining of whether to send the default value for each of the plurality of Validate bits includes determining a version of the second wireless station; and the version is: Release 1 of WiFi standard 802.11 be, or Release 2 of WiFi standard 802.11 be.

### BRIEF DESCRIPTION OF THE DRAWINGS

These and other features and advantages of the present disclosure will be appreciated and understood with reference to the specification, claims, and appended drawings wherein:

FIG. 1 is a format diagram, according to an embodiment of the present disclosure;

FIG. 2A is a format diagram, according to an embodiment of the present disclosure;

FIG. 2B is a format diagram, according to an embodiment of the present disclosure;

FIG. 2C is a format diagram, according to an embodiment of the present disclosure;

FIG. 3 is a flowchart of a method, according to an embodiment of the present disclosure; and

FIG. 4 is a block diagram of a WiFi system, according to an embodiment of the present disclosure.

### DETAILED DESCRIPTION

The detailed description set forth below in connection with the appended drawings is intended as a description of exemplary embodiments of a system and method for selecting values for Validate and Disregard bits provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

In a WiFi system, physical layer protocol data units (PPDUs) may be exchanged between the different stations (STAs) in the system, including Access Point stations (AP STAs) and non-AP STAs. In general, the version of the standard (which may be a version of WiFi standard 802.11 set by the Institute of Electrical and Electronics Engineers (IEEE)) that any STA (or “device”) conforms with may vary, depending, for example, on when the STA was designed, manufactured, and sold. The WiFi standard 802.11 be is being defined in two releases, a first release (Release 1) and a second release (Release 2). A STA that conforms with 802.11 be Release 1 may be referred to herein as a Release 1 STA, and a STA that conforms with 802.11 be Release 2 may be referred to herein as a Release 2 STA.

A Release 1 STA implements only 802.11 be Release 1 features, and a Release 2 STA may implement both Release 1 and Release 2 features. Release 2, when finalized, may include physical layer (PHY) features including an aggregated physical layer protocol data unit (APPDU), subchannel selective transmission (SST), and an extremely high throughput (EHT) extended range (ER) PPDU.

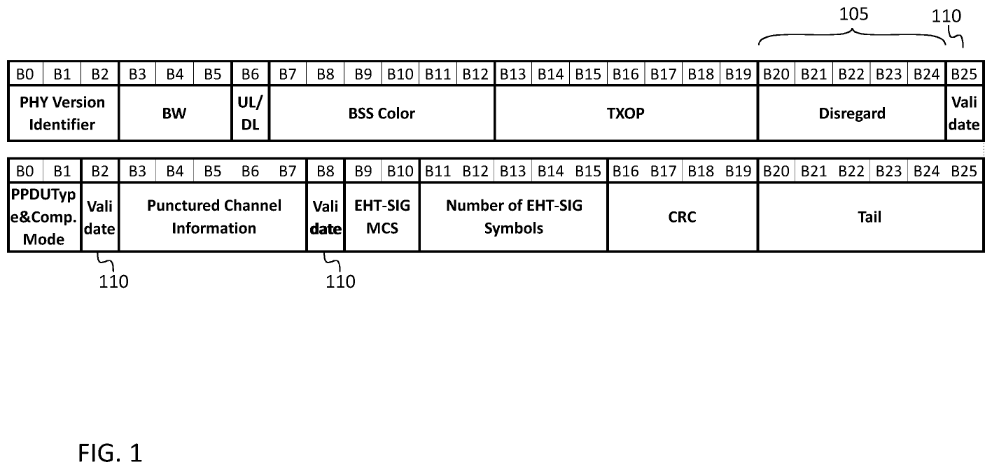

In Release 1, each EHT PPDU includes a Universal signal (U-SIG) field with variations for multi-user (MU) PPDUs and trigger based (TB) PPDUs. FIG. 1 shows the format of the EHT MU PPDU U-SIG field. This field includes two symbols, U-SIG symbol 1 and U-SIG symbol 2. The U-SIG field contains Disregard bits 105 (discussed in further detail below) from B20-B24 in U-SIG symbol 1, and it contains Validate bits 110 (discussed in further detail below) in B25 of U-SIG symbol 1 and in B2 and B8 of U-SIG symbol 2.

Release 1 specifies certain behaviors that a STA must exhibit for certain settings of the Validate and Disregard bits. For example, if an EHT STA encounters a PPDU where at least one field in the preamble that is identified as Validate for the STA is not set to a default value specified for the field, the STA is required to defer for the duration of the PPDU, and terminate the reception of the PPDU. As another example, if an EHT STA sees any of the fields identified as Disregard for the STA not set to a default value specified for the field, the STA is required to ignore these field values and they will have no impact on STA's continued reception of the PPDU.

In Release 2, the Validate and Disregard bits may be used for other features or be extended for use with existing features. To the extent this is the case, a Release 2 STA may on occasion transmit a PPDU with Validate or Disregard bits that are not set to their default values. If such a PPDU is received by a Release 1 STA, the presence of Validate or Disregard bits not set to their default values may trigger the above-described mandatory behaviors, which may adversely affect the performance of the communication link between the STAs. For example, if a first STA, which is a Release 2 STA, sends a PPDU to a second STA, which is a Release 1 STA, and if the first STA is not aware that the second STA is a Release 1 STA, the first STA may transmit to the second STA a PPDU with Validate bits not set to their default value, and the second STA may, as required by Release 1, terminate the reception of the PPDU, resulting in the PPDU being dropped by the second STA.

Moreover, even if the PPDU is not dropped (e.g., if the Validate bits are set to their default value) the second STA may not be able to receive the information transmitted in the Disregard bits, potentially resulting in a discrepancy between (i) the information the first STA has transmitted to the second STA (and that the first STA assumes is in the possession of the second STA) and (ii) the information received by the second STA.

Two possible scenarios may be considered when a Release 2 STA transmits to a Release 1 STA. In a first scenario, Disregard bits are used for some mandatory features, and in a second scenario, Validate bits are used with value(s) different from the default value in Release 1. To avoid performance degradation that could occur in the first scenario, the use of Disregard bits for potentially mandatory features that are shared for all users in the transmission may be avoided; such features may instead use only Validate bits.

To avoid performance degradation that could occur in the second scenario, two solutions may be considered. The first such solution is that, for Validate bits, the Release 2 standard may define the same value as default values in Release 1 (all 1s) for the default option in Release 2. The second such solution is that each Release 2 STA may indicate its version (e.g., the version being Release 1 (of WiFi standard 802.11 be) or Release 2 (of WiFi standard 802.11 be)) to other STAs such that other STAs can avoid sending PPDUs with non-default values to Release 1 STAs.

Various methods may be used by a STA to indicate its version to another STA. Because release version is a stable property of a STA, the EHT Capabilities element (which is an information element (IE) in a PPDU) may be used to indicate (e.g., using a version-indicating bit) the version of the STA transmitting the EHT Capabilities element, or the receiving STA may infer the release version of the STA from the EHT Capabilities element or from another information element. As used herein, a “version-indicating bit” is a bit that (i) when transmitted by a Release 2 STA is always set to a first value, and that (ii) if transmitted by a Release 1 STA, is always set to a second value, different from the first value (e.g., it is a bit transmitted by a STA for the sole purpose of indicating the version of the transmitting STA). As used herein, “inferring” the version of a STA means determining the version of the transmitting STA without relying on the value of a version-indicating bit.

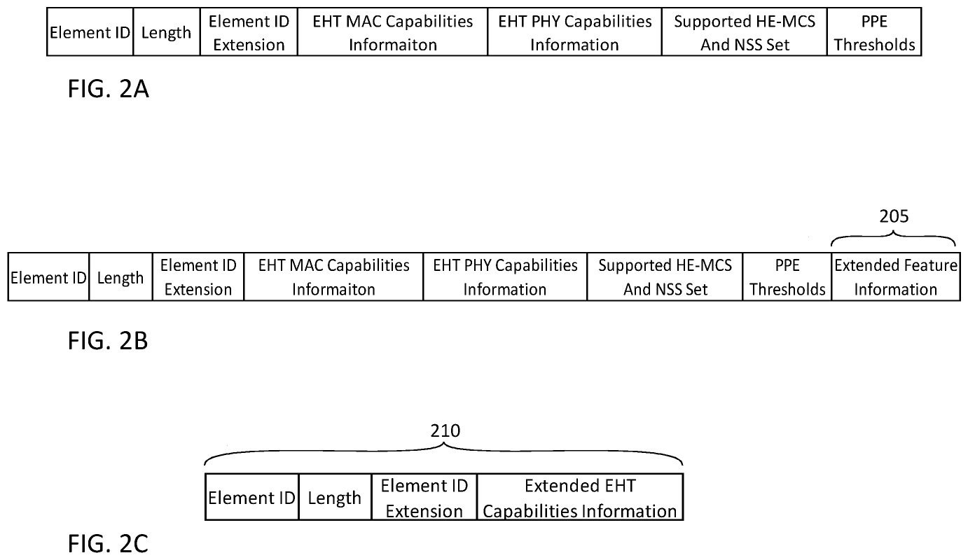

FIG. 2A shows the Release 1 format of the EHT Capabilities element. In Release 2, if the length of the EHT Capabilities element is specified to be flexible, then an extended feature information field 205 may be appended to the EHT Capabilities element. Otherwise, a new information element 210 may be defined to convey information related to the transmitting STAs capabilities with respect to Release 2 features. In some embodiments, any of three principal approaches (which may be referred to herein as Option 1, Option 2 and Option 3) for determining the version of a STA may be employed.

A first approach (which may be referred to as Option 1) is to infer from the values of certain EHT capability bits that a STA is a Release 2 STA (because a Release 1 STA would transmit default values for such bits); these capability bits may be bits (i) which are reserved in Release 1, (ii) each of which may be used, in Release 2, to signal the capability to support a respective Release 2 feature, and (iii) which are set to non-default values. Similarly, the presence of a new information element 210 in a PPDU transmitted by a STA may be used to infer that the transmitting STA is a Release 2 STA.

This approach may have the advantage that it does not require the allocation of an additional bit as a version-indicating bit. In some circumstances, if a new information element 210 does not become part of Release 2, or if the transmitting of such an information element 210 is optional in Release 2, then it may not be possible for a first STA, which receives a PPDU from a second STA, to determine the version of the second STA if the PPDU does not include a new information element 210 and if all of the reserved bits are set to their Release 1 default values (which may occur if the second STA does not support any of the optional Release 2 features to which the reserved bits correspond). In such a situation, the first STA may treat the second STA as a Release 1 STA, and forego the use of Release 2 features (including mandatory Release 2 features).

A second approach (which may be referred to as Option 2) is to use the length (or the value of the length field) of the EHT Capabilities element to infer that a STA is a Release 2 STA. If a first STA, which receives, from a second STA, a PPDU including an EHT Capabilities element with a length greater than the maximum permissible length, in Release 1, for an EHT Capabilities element, then the first STA may infer that the second STA is a Release 2 STA. Moreover, if the minimum Release 2 length of the EHT Capabilities element exceeds the maximum Release 1 length of the EHT Capabilities element, then if the length of the EHT Capabilities element is less than the minimum Release 2 length of the EHT Capabilities element, the first STA may infer that the second STA is a Release 1 STA. This approach may have the advantage that it does not require the allocation of an additional bit as a version-indicating bit. In some circumstances, if it is permissible, in Release 2, for a Release 2 STA to transmit an EHT Capabilities element that is not longer than the longest permissible EHT Capabilities element in Release one, then it may not be possible for a first STA, which receives a PPDU from a second STA, to determine the version of a second STA if the PPDU does not include an EHT Capabilities element that would be impermissibly long under Release 1. In such a situation, the first STA may treat the second STA as a Release 1 STA, and forego the use of Release 2 features (including mandatory Release 2 features).

A third approach (which may be referred to as Option 3) is to use a version-indicating bit to signal that a STA is a Release 2 STA. This bit may be a dedicated bit (e.g., (i) a bit in the EHT Capabilities element that is a reserved bit under Release 1, or (ii) a bit in a new extended feature information field 205 (added to the EHT Capabilities element in Release 2), or (iii) a bit in a new information element 210) which, when set to a specified value in a PPDU transmitted by a STA, signals that the STA is a Release 2 STA. If the version-indicating bit received by a first STA from a second STA is set to a value that indicates that the second STA is a Release 2 STA, then the first STA may determine from the bit's being set to that value that the version of the second STA is Release 2. The version-indicating bit may be described in various ways. For example, it may be described as a grouping indication of Release 2 mandatory features, i.e., as a bit that indicates whether the STA supports the mandatory features of Release 2. As another example, the version-indicating bit may be described as a U-SIG Validate bits support indicating bit, i.e., a bit that signals support for the Release 2 feature of not checking the Validate bits. If this bit is set to true, then the corresponding STA is a Release 2 STA. As another example, the version-indicating bit may be described as an indication bit for the conditional mandatory features. In this case, all Release 2 mandatory features are considered to be conditional mandatory. Only when the indication of supporting conditional mandatory features is set to be true, Release 2 is supported by this device. As another example, if Release 2 mandates (i) the existence of extra octets in the EHT capabilities element and (ii) the transmission of a bit that indicates the existence of extra octets in the EHT capabilities element, then this bit may be used as a version-indicating bit. If this bit is true, there will be extra octets in the EHT capabilities element, and the corresponding STA is a Release 2 STA.

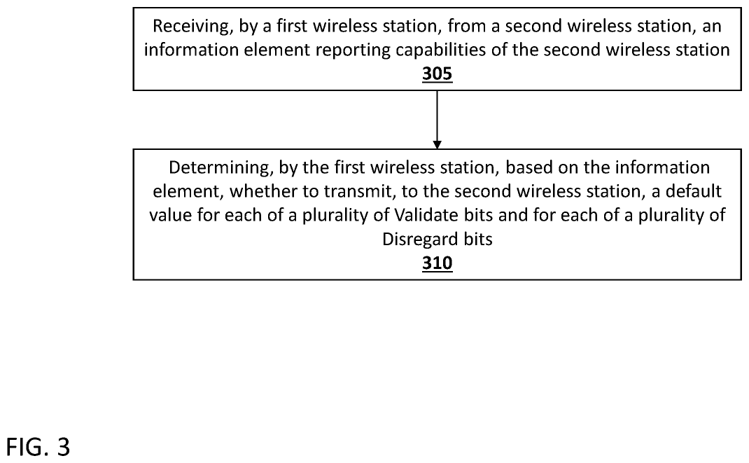

FIG. 3 shows a flowchart of a method, in some embodiments. The method includes receiving, at 305, by a first wireless station (e.g., by a first STA), from a second wireless station (e.g., from a second STA), an information element reporting capabilities of the second wireless station; and determining, at 310, by the first wireless station, based on the information element, whether to transmit, to the second wireless station, a default value for each of a plurality of Validate bits and for each of a plurality of Disregard bits. This determining may involve first determining whether the second STA is a Release 1 STA or a Release 2 STA. If the first STA determines that the second STA is a Release 1 STA, or if the first STA is not able to determine whether the second STA is a Release 1 STA or a Release 2 STA, then the first STA may determine to send the default value for each Validate bit and for each Disregard bit. If the first STA determines that the second STA is a Release 2 STA, then the first STA may determine to send one or more Validate or Disregard bits with values that are different from the default values.

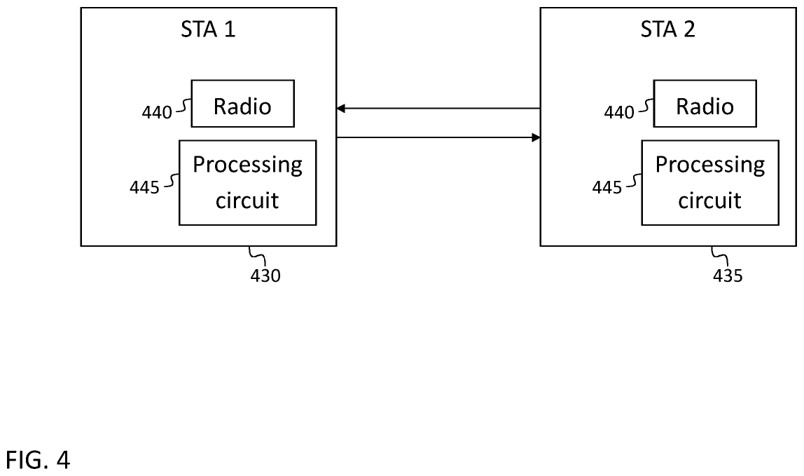

FIG. 4 shows a system including a first STA 430 and a second STA 435, in communication with each other. Each of first STA 430 and a second STA 435 may include a respective radio 440 and a respective processing circuit (or a means for processing) 445, which may perform various methods disclosed herein, e.g., the processing circuit 445 of the first STA 430 may perform (using the radio 440 of the first STA 430) the method illustrated in FIG. 3. For example, the processing circuit 445 of the first STA 430 may receive, via the radio 440 of the first STA 430, transmissions from the second STA 435, and the processing circuit 445 of the first STA 430 may transmit, via the radio 440 of the first STA 430, signals to the second STA 435.

As used herein, “a portion of” something means “at least some of” the thing, and as such may mean less than all of, or all of, the thing. As such, “a portion of” a thing includes the entire thing as a special case, i.e., the entire thing is an example of a portion of the thing. As used herein, the term “or” should be interpreted as “and/or”, such that, for example, “A or B” means any one of “A” or “B” or “A and B”.

The terms “processing circuit” and “means for processing” are used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

It will be understood that when an element or layer is referred to as being “on”, “connected to”, “coupled to”, or “adjacent to” another element or layer, it may be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

Any numerical range recited herein is intended to include all sub-ranges of the same numerical precision subsumed within the recited range. For example, a range of “1.0 to 10.0” or “between 1.0 and 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Similarly, a range described as “within 35% of 10” is intended to include all subranges between (and including) the recited minimum value of 6.5 (i.e., (1−35/100) times 10) and the recited maximum value of 13.5 (i.e., (1+35/100) times 10), that is, having a minimum value equal to or greater than 6.5 and a maximum value equal to or less than 13.5, such as, for example, 7.4 to 10.6. Any maximum numerical limitation recited herein is intended to include all lower numerical limitations subsumed therein and any minimum numerical limitation recited in this specification is intended to include all higher numerical limitations subsumed therein.

Although exemplary embodiments of a system and method for selecting values for Validate and Disregard bits have been specifically described and illustrated herein, many modifications and variations will be apparent to those skilled in the art. Accordingly, it is to be understood that a system and method for selecting values for Validate and Disregard bits constructed according to principles of this disclosure may be embodied other than as specifically described herein. The invention is also defined in the following claims, and equivalents thereof.

What is claimed is:

1. A method, comprising:
receiving, by a first wireless station, from a second wireless station, an information element reporting capabilities of the second wireless station; and
determining, by the first wireless station, based on the information element, whether to transmit, to the second wireless station, a default value for each of a plurality of Validate bits and for each of a plurality of Disregard bits.

2. The method of claim 1, wherein the determining of whether to send the default value for each of the plurality of Validate bits comprises determining a version of the second wireless station.

3. The method of claim 2, wherein the version is:
Release 1 of WiFi standard 802.11 be, or
Release 2 of WiFi standard 802.11 be.

4. The method of claim 3, wherein:
the information element is an Extremely High Throughput Capabilities element, and
the determining comprises inferring, from the information element, the version.

5. The method of claim 4, wherein the inferring comprises inferring from a first bit being set to a first value that the version is Release 2,
the first bit being a Release 1 reserved bit and the first value being a non-default value of the first bit.

6. The method of claim 4, wherein the inferring comprises inferring from the length of the information element that the version is Release 2.

7. The method of claim 4, wherein the inferring comprises inferring from the length of the information element that the version is Release 1.

8. The method of claim 3, wherein:
the determining comprises determining from a first bit being set to a first value that the version is Release 2, and
the first bit is a version-indicating bit.

9. The method of claim 3, wherein:
the version is Release 1, and
the method further comprises transmitting, to the second wireless station, the default value for each of the plurality of Validate bits and for each of the plurality of Disregard bits.

10. A system, comprising:
a first wireless station comprising a radio and a processing circuit,
the processing circuit being configured to:
receive, from a second wireless station, an information element reporting capabilities of the second wireless station; and
determine, based on the information element, whether to transmit, to the second wireless station, a default value for each of a plurality of Validate bits and for each of a plurality of Disregard bits.

11. The system of claim 10, wherein the determining of whether to send the default value for each of the plurality of Validate bits comprises determining a version of the second wireless station.

12. The system of claim 11, wherein the version is:
Release 1 of WiFi standard 802.11 be, or
Release 2 of WiFi standard 802.11 be.

13. The system of claim 12, wherein:
the information element is an Extremely High Throughput Capabilities element, and
the determining comprises inferring, from the information element, the version.

14. The system of claim 13, wherein the inferring comprises inferring from a first bit being set to a first value that the version is Release 2,
the first bit being a Release 1 reserved bit and the first value being a non-default value of the first bit.

15. The system of claim 13, wherein the inferring comprises inferring from the length of the information element that the version is Release 2.

16. The system of claim 13, wherein the inferring comprises inferring from the length of the information element that the version is Release 1.

17. The system of claim 12, wherein:
the determining comprises determining from a first bit being set to a first value that the version is Release 2, and
the first bit is a version-indicating bit.

18. The system of claim 12, wherein:
the version is Release 1, and
the processing circuit is further configured to transmit, to the second wireless station, the default value for each of the plurality of Validate bits and for each of the plurality of Disregard bits.

19. A system, comprising:
a first wireless station comprising a radio and means for processing,
the means for processing being configured to:
receive, from a second wireless station, an information element reporting capabilities of the second wireless station; and
determine, based on the information element, whether to transmit, to the second wireless station, a default value for each of a plurality of Validate bits and for each of a plurality of Disregard bits.

20. The system of claim 19, wherein:
the determining of whether to send the default value for each of the plurality of Validate bits comprises determining a version of the second wireless station; and
the version is:
Release 1 of WiFi standard 802.11 be, or
Release 2 of WiFi standard 802.11 be.
